(19) United States
(12) Patent Application Publication
(10) Pub. No.: US 2012/0287763 A1
(43) Pub. Date: Nov. 15, 2012

(54) TIMEPIECE WITH INTERCHANGEABLE DISPLAY AND SOUNDS

(75) Inventor: William Knox, JR., Painesville, OH (US)

(73) Assignee: Mag-Nif Incorporated

(21) Appl. No.: 13/111,692

(22) Filed: May 19, 2011

Related U.S. Application Data
(60) Provisional application No. 61/485,860, filed on May 13, 2011.

(51) Int. Cl. G04C 21/00

(52) U.S. Cl. 368/250

(57) ABSTRACT

The present disclosure pertains to a timepiece including at least one plate such that the at least one plate is associated with at least one sound. The timepiece includes a housing having a front opening. The at least one plate is supported by the housing such that the at least one plate is viewable through the front opening. A circuit establishing portion is disposed on each dial. A controller is adapted to be activated by the contact portion of the selected dial. The controller is programmed to transmit at least one sound corresponding with the at least one plate, each audible sound is transmitted at a predetermined time.

### BACKGROUND

The present exemplary embodiment relates to a timepiece that displays indicia. It finds particular application in conjunction with timepieces including interchangeable dials, each of which features indicia and transmits unique sounds associated with that dial, and will be described with particular reference thereto. However, it is to be appreciated that the present exemplary embodiment is also amenable to other like applications.

Timepieces, both clocks and watches, function not only as timekeeping devices but also as decorative objects. Notably, timepiece technology has advanced such that time keeping accuracy is reliable and economical to produce in the market. The current market demand for timepieces is more focused towards the decorative aspect of the device rather than the level of accuracy of timekeeping. The challenge for manufacturers is to provide a variety of designs and styles that are attractive to a consumer while keeping manufacturing costs low.

In response to market demand, manufacturers have provided timepieces with interchangeable dials that allow a consumer to change the style and appearance of the timepiece to the taste of the consumer. Additionally, there are timepieces that are known to include dials which display designs or graphics associated with each unit of time. Some of these timepieces transmit corresponding sounds in association with a predetermined time that is displayed on the dial.

For example, one manufacturer has provided a bird clock that includes graphic depictions of twelve different birds, each bird corresponding with an hour on the dial such that a different “bird chirp” sound would chime at each hour. Various forms of clocks and watches are known which have different designs or style features and which broadcast a sound or chime with each corresponding hour or otherwise as determined by the user. Cuckoo clocks are an example.

There are many other types of clock systems having similar features. However, there remains a need for a timepiece having interchangeable dials with each dial being coupled to its own individual suite of sounds such that changing the viewable dial on the timepiece also changes the sounds that will be generated by the timepiece.

### BRIEF DESCRIPTION

In one embodiment the present disclosure pertains to a timepiece including a plurality of plates such that each plate is associated with at least one sound. The timepiece comprises a housing including a front opening. At least one plate is supported by the housing such that the at least one plate is viewable through the front opening. A circuit establishing portion is disposed on the at least one plate and a controller is adapted to be activated by the circuit establishing portion of the at least one plate. The controller is programmed to transmit at least one sound corresponding with the at least one plate. The at least one audible sound being transmitted at a predetermined time.

In another embodiment of the present disclosure, provided is a method of displaying one of a plurality of plates such that each plate includes at least one indicium, in a housing, wherein the at least one indicium is operatively associated with at least one sound. The method comprises selecting a plate having at least one indicium from a plurality of plates to be viewed in the housing. The plurality of plates are positioned in a stackable arrangement in the housing such that only the selected plate is visible. At least one sound associated with the at least one indicium on the selected plate is transmitted at a predetermined time.

In still another embodiment, provided is a timepiece that includes a plurality of plates such that each plate is associated with at least one sound. The timepiece comprises a housing including a front opening. A plurality of plates are configured in a stacked arrangement and placed within the housing such that a selected plate is viewable through the front opening. A circuit establishing portion provided on at least one of the plurality of plates. A time display mechanism held within the housing and viewable through the front opening. A controller in communication with the circuit establishing portion, the controller being programmed to transmit, at a predetermined time, at least one sound corresponding with the selected plate.

### BRIEF DESCRIPTION OF THE DRAWINGS

The present disclosure may take form in certain parts and arrangements of parts, several embodiments of which will be described in detail in this specification and illustrated in the accompanying drawings which form a part hereof and wherein:

FIG. 1 is an exploded perspective view of a first embodiment of a timepiece assembly according to the present disclosure;

FIG. 2 is an enlarged fragmentary perspective view of a plurality of stacked dials in a stackable arrangement of the timepiece assembly of FIG. 1;

FIG. 3A is a side view of an embodiment of a contactor member in communication with a first selected dial of the timepiece assembly of FIG. 1;

FIG. 3B is a side view of the contactor member of FIG. 3A in communication with a second selected dial of the timepiece assembly;

FIG. 3C is a side view of the contactor member of FIG. 3A in communication with a third selected dial of the timepiece assembly;

FIG. 3D is a side view of the contactor member of FIG. 3A in communication with a fourth selected dial of the timepiece assembly;

FIG. 4 is an exploded perspective view of a second embodiment of a timepiece assembly according to the present disclosure;

FIG. 5 is a top plan view of selected components of the timepiece assembly of FIG. 4.

### DETAILED DESCRIPTION

It is to be understood that the detailed figures are for purposes of illustrating exemplary embodiments of the present disclosure only and are not intended to be limiting. Additionally, it will be appreciated that the drawings are not to scale and that portions of certain elements may be exaggerated for the purpose of clarity and ease of illustration.

In accordance with the present disclosure, a timepiece is provided having interchangeable plates with each plate being coupled to its own suite of sounds such that changing the plate on the timepiece also changes the sounds to be generated by the timepiece. While “plates” are discussed herein, it should be appreciated that the term is meant to encompass discs, rings, dials or clock/watch faces having numerous possible configurations. The timepiece can include a group of changing graphic rings or dials that works in concert with a set of sounds.

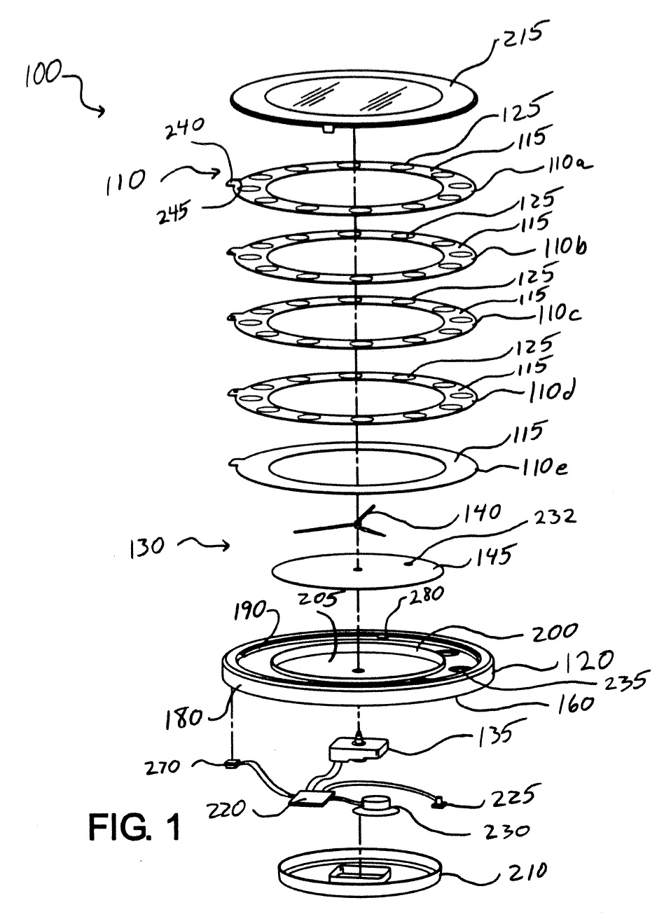

With reference to FIG. 1, a first embodiment of a timepiece 100 is illustrated in an exploded perspective view. The timepiece 100 includes a plurality of interchangeable plates, discs or dial faces 110a, 110b, 110c, 110d and 110e configured in a stackable arrangement within a housing 120. The dial faces 110a-110e can be generally ring shaped or toroidal and can include at least one indicium 125 disposed around a viewable surface 115 of each dial 110a-110d. The indicia 125 can be one or more colors, designs, pictures, numbers, etc. In this embodiment, the dial 110e does not include indicia and is blank. Of course, the dial 110e could also be provided with a single indicium or a plurality of indicia if so desired. The housing 120 is adapted to support the plurality of dials 110a-110e along with a time display mechanism 130 including clock hands 140 and a central clock face 145 that is operable to be viewed from a front opening of the housing 120. The time display mechanism 130 includes a movement device 135 that is axially aligned with the clock hands 140 and clock face 145 and adapted to move the clock hands 140 around clock face 145 to indicate the time of day. Indicia representing the hours can optionally be provided on the viewable surface 115 or the clock face 145 as desired.

A selected dial 110 is positioned atop the stackable arrangement of the plurality of dials 110a-110e such that the viewable surface 115 of the selected dial 110 is visible from the housing 120. The user selects one of the dials 110a-110e and positions that dial on top of the stackable arrangement such that the selected dial 110 is simultaneously viewable with the time display mechanism 130 in the housing 120. In one embodiment, the housing 120 is adapted to support the selected dial 110 but the remaining, unselected dials are not stored in the housing 120. Rather, they are stored in a location separated from the housing 120. Alternatively, a storage compartment could be mounted to a rear face of the housing 120 such that only the selected dial 110 is held in the housing 120.

The time display mechanism 130 can include an analog movement device 135 that displays the time by rotating the clock hands 140 relative to the clock face 145 such that the clock hands 140 point to the indicia 125 disposed around the viewable surface 115 of the selected dial 110 that is representative of the time of the day. The movement device 135 can include a battery compartment which provides electric power to the timepiece. Alternatively, the timepiece can be A.C. powered via a power source including a plug connected to an electrical outlet (not shown). In another embodiment, the time display mechanism 130 may be a digital type display device.

The housing 120 can include a rear panel 160. In one embodiment, the housing 120 includes a toroidal outer wall 180. An annular cavity 190 is defined between the outer wall 180 and a toroidal inner wall 200. The cavity 190 houses the plurality of stacked ring-shaped dials 110a-110e held by the housing 120. Defined by the inner wall 200 is a circular cavity 205 which is configured to receive the clock face 145 of the time display mechanism 130. The housing 120 is optionally provided with a back cover 210 and a front cover 215. The back cover 210 is adapted to enclose other components of the timepiece 100 including a controller 220, a light sensor 225, a speaker 230 and the movement device 135 of the time display mechanism 130. The controller 220 can include a memory chip for storing sounds and an integrated circuit which regulates the transmission of sounds by the speaker 230. The controller 220 can be a printed circuit board having a plurality of contacts adapted to give and receive signals from the components of the timepiece 100. The front cover 215 includes a transparent lens that allows the user to view the selected dial 110. An aperture 232 is provided in the clock face 145 and is aligned with the light sensor 225 to allow the light sensor 225 to sense light passing through the front cover 215. In one embodiment, the light sensor 225 is capable of sensing the presence of light entering through the opening 232 in the clock face 145 such that once light is identified by the light sensor 225, the timepiece 100 is operative to transmit sounds at predetermined times. If light is not sensed by the light sensor 225, the timepiece 100 will not transmit sounds, such as at night.

The front cover 215 can be opened or moved out of the way to allow access to the interior of the housing 120 enabling the operator to change the stacking order of the dials 110a-110e. Additionally, at least one aperture 235 is provided in the housing 120. Such apertures 235 are accessible from a rear face of the housing 120 and are adapted to receive an elongated member, such as a pen or a finger of the user to contact the dials 110a-110e. In this way, the dials 110a-110e can be pushed out of the annual cavity 190 and their stacking order can be changed by the user.

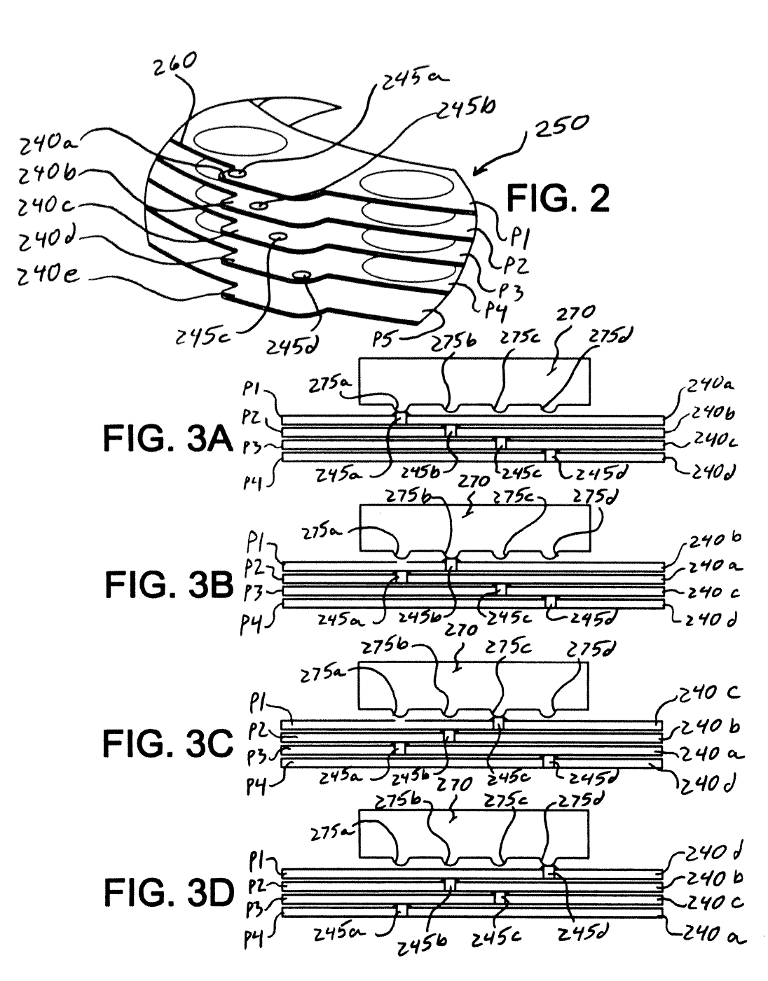

In the embodiment shown in FIG. 2, each of the dials 110a-110e includes identical protruding tabs 240a, 240b, 240c, 240d and 240e. The tabs 240a-240e can extend radially outward from an outer edge 260 of each dial 110a-110e. The tabs 240a-240e are radially aligned in the stackable arrangement of dials 110a-110e. The first four tabs 240a-240d can each include a circuit establishing portion in the form of a contact pin 245a, 245b, 245c and 245d. The circuit establishing portion could optionally be configured as a mechanical or electrical type switch member. As is evident from FIG. 2, the contact pins 245a-245d are radially staggered along the four tabs 240a-240d in the stackable arrangement. The tabs 240a-240e and contacts 245a-245d are aligned in the housing 120 such that the dial which is the closest to the front cover 215 becomes the selected dial 110. As illustrated in FIG. 1, the tabs 240a-240e are received within the housing 120 in a pocket 280 formed along a portion of the outer wall 180. For the sake of visibility, the pocket 280 is shown such that the housing 120 is rotated from the orientation of the dials 110a-110e.

FIGS. 1 and 2 illustrate an embodiment which includes five dials 110a-110e. Of course, any desired number of dials can be employed and this disclosure is not limited in this regard. Each dial 110a-110e is configured to be interchangeably positioned at a position P1, P2, P3, P4 and P5 of the stackable arrangement within the housing 120. Position P1 is the top of the stackable arrangement and closest to the front opening of the housing 120 such that the selected dial 110 can be brought into communication with a circuit element such as contactor member 270. Position P5 is opposite from position P1 and is directly adjacent the rear panel 160. Notably, dial 110e does not include a contact pin or indicia and is located at position P5 within the stackable arrangement. If no sounds or indicia are desired, then dial 110e can be positioned atop the stack of dials 110a-110e at position P1.

FIGS. 3A-3D illustrates tabs 240a-240d of dials 110a-110d respectively. The dials 110a-110e and associated tabs and contact pins 245a-245d are interchangeably aligned with the contactor member 270. The contactor member 270 includes a plurality of protuberances 275a, 275b, 275c and 275d such that each protuberance 275a-275d is adapted to come in contact with a respective one of the staggered contacts 245a-245d when the selected dial 110 is located in position P1. Notably, the circuit element in the form of contactor member 270 is optionally configured to be an electrical or mechanical type switch that is activated by its communication with the selected dial 110. In one embodiment, the protuberances 275a-275d of contactor member 270 are spring loaded type switches adapted to selectively communicate with the controller 220. Each protuberance could, for example, include 2 wires that when contacted, signal the controller 220. This would occur when the spring loaded protuberance is depressed by the contact pin from the selected dial 110. In this embodiment, the contactor member 270 and the contact pins 245a-245d are the vehicle for identifying which dial is the selected dial 110 such that the at least one sound associated with that dial is transmitted at a predetermined time.

The controller 220 is in electric communication with the contactor member 270, the speaker 230, the light sensor 225 and the movement device 135 of the time display mechanism 130. The controller 220 is adapted to transmit at least one sound and could transmit a unique suite of sounds corresponding with one or more images or indicia on the selected dial 110. As each dial 110a-110d is chosen as the selected dial 110, the controller transmits a sound or suite of sounds that are related to the indicia 125 contained on that dial 110a-110d as it is viewable in the annular cavity 190 of the housing 120. Each audible sound in the suite of sounds could be individually transmitted through the speaker 230 at a predetermined time as indicated by the time display mechanism 130 and could be related to the specific indicium 125 at which an hour hand of the clock hands 140 points. The predetermined time can indicate each hour but could be programmed by the user to indicate different intervals of times of the day, if so desired. For example, a dial 110 can be provided with four indicia and the controller 220 can be programmed to transmit four sounds at a predetermined time associated with each of the four indicia. The four indicia can be radially spaced around the dial 110, for example, at positions related to 3:00, 6:00, 9:00 and 12:00 (AM and PM). Additionally, the sound or sounds could be repeated when the hour hand of the clock points to a predetermined time. For example, the sound could be transmitted and repeated three times as the clock hour hand 140 points to indicia aligned with 3:00.

The selected dial 110 includes at least one of the tabs 240a-240e whereby tabs 240a-240d include contact pins 245a-245d that can be in electrical or mechanical communication with a respective protrusion 275a-275d of the contactor member 270. Alternatively, with reference to FIG. 3A, the contact pin 245a on the selected dial 110 can be adapted to activate the contactor member 270 such that the protrusion 275a closes an electrical circuit isolated from the other protrusions 275b-275d and contact pins 245b-245d. In this embodiment, a signal identifying which dial 110a-110d is the selected dial 110 can be communicated to the controller 220 such that a suite of sounds associated with that dial 110a-110d can be transmitted at predetermined times. Similarly, with reference to FIGS. 3B, 3C and 3D, contact pins 245b-245d can be adapted to activate the contactor member 270 such that protrusions 275b-275d, respectively close an electrical circuit isolated from the other protrusions and contact pins to identify which dial 110b-110d is the selected dial 110 to the controller 220.

In one embodiment, the circuit establishing portion of the selected dial and the controller 220 can communicate electronically with a circuit element such as an infrared type sensing device (not shown). The infrared sensing device can be configured to shut off or to establish communication between the selected dial 110 and the controller 220 via completing a light path. The infrared sensing device could be located within the housing 120 along the toroidal outer wall 180. The dials and circuit establishing portion can be adapted to complete the light path when the selected dial is in position P1 and viewable in the housing 120. Once the light path is established, a signal is provided to the controller 220 to identify which dial 110a-110d is the selected dial 110 and to transmit the at least one sound associated with that dial 110 at one or more predetermined times. Other embodiments could include graphic element rings which complete a circuit without the need for protrusions on the rings. There are a number of other known ways of completing a circuit with the controller.

In one embodiment, each dial 110a-110d is provided with twelve indicia 125 that are radially positioned about each dial 110a-110d such that each indicium of the twelve indicia 125 are equally spaced around the viewable surface 115. In the disclosed embodiment, the indicia 125 are configured to identify the twelve hours of each half day similar to contemporary dial faces of known timepieces. The audible suite of sounds associated with each dial 110a-110d could include twelve individual and unique sounds with one being associated with each indicium 125. For example, one sound can be associated with multiple indicia on a dial or a single indicium can be associated with a unique sound for each indicium. Of course, with a clock displaying a different number of hours, a different number of indicia could be employed such that one is related to each of the hours. For example, a 24 hour clock could employ 24 related indicia. Alternately, a clock could employ only 4 related indicia, each associated with one sound so that the clock would sound 4 times a day. Additionally, the indicia and the sounds could be programmed or changed by the user if so desired. For example, the housing could include a thumb drive socket (not shown) allowing a thumb drive to communicate with the controller 220 so that additional sounds could be provided.

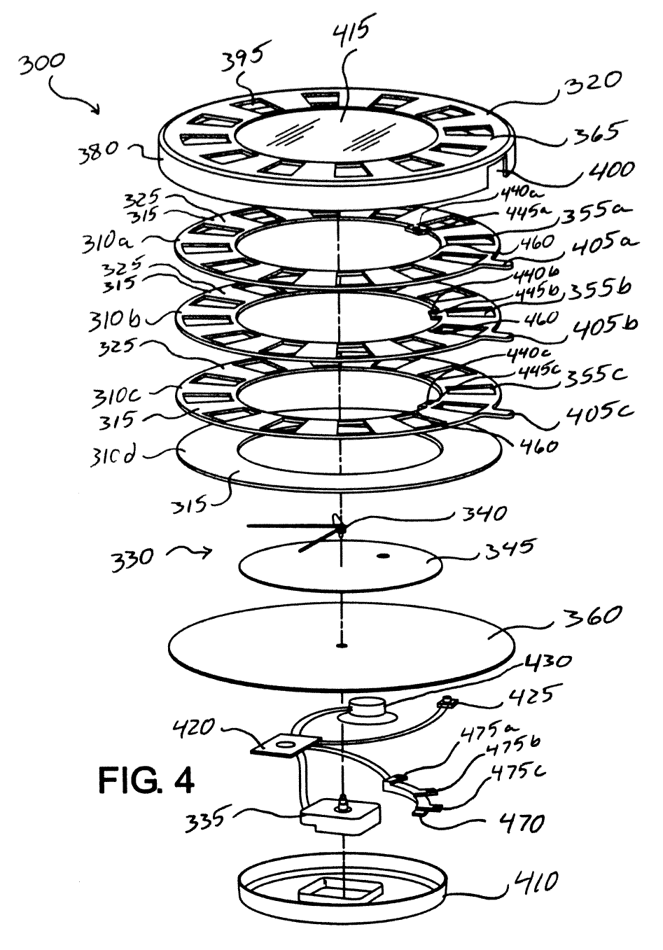

With reference to FIG. 4, a second embodiment of a timepiece 300 is illustrated in an exploded perspective view. The timepiece 300 includes a plurality of faces or dials 310a, 310b, 310c and 310d configured in a stacked arrangement within a housing 320. The dials 310a-310d are generally ring shaped. The first three dials 310a-310c each include a plurality of indicia 325 located at a viewable surface 315 of each dial. In this embodiment, the fourth dial 310d has no such indicia. The housing 320 is adapted to support the plurality of dials 310a-310d along with a time display mechanism 330 such as clock hands 340 with a clock face 345 that is operable to be viewed through a front opening in the housing 320. The time display mechanism 330 includes a movement device 335 that is axially aligned with the clock hands 340 and clock face 345 and adapted to move the clock hands 340 around the clock face 345 to indicate the time of day in reference to indicia 325 disposed around the viewable surface 315.

The timepiece 300 is configured so that a user can select viewable indicia 325 from one of the plurality of dials 310a-310d while each dial remains located within the housing 320. A selected dial is positioned in the stacked arrangement of the plurality of dials 310a-310d such that the viewable surface 315 of the selected dial is in a selected position and is thus viewable in the housing 320. In this embodiment, the indicia 325 on each dial 310a-310c are separated from each other by openings or windows 355a, 355b and 355c. The selected dial is rotated by the user so that the indicia 325 become visible through the plurality of aligned windows 355a-355c of the other two dials. The selected dial is simultaneously viewable along with the time display mechanism 330. The time display mechanism 330 displays the time and the movement device 335 rotates clock hands 340 relative to a clock face 345 such that the clock hands 340 point to specific indicia 325 at specific times of the day.

The housing 320 includes a rear panel 360 and a front panel 365 oppositely disposed from the rear panel 360. The front panel 365 includes a perimeter wall 380 or skirt that extends downwardly to abut the rear panel 360 and enclose the plurality of stacked dials 310a-310d held in the housing 320. A radial opening or gap 400 is provided in the perimeter wall 380. This allows selecting tabs 405a, 405b and 405c of the dials 310a-310c to protrude through the gap 400. The selecting tabs 405a-405c are operable via rotation to position a desired one of the dials 310a-310d such that portions of it are visible through windows 355a-355c while the dials 310a-310d remain in the stackable arrangement within the housing 320.

The housing front panel 365 includes a plurality of windows 395 of generally the same size and shape as the windows 355a-355c in the dials 310a-310c. The windows 395 are radially spaced around the front panel 365 in selective alignment with windows 355a-355c of dials 310a-310c such that the plurality of indicia 325 located on the plurality of dials 310a-310c are selectively viewable through windows 395 of the front panel 365. In this embodiment, the dial 310d does not contain indicia. It is blank. Of course, the dial 310d could also be provided with a single indicium or a plurality of indicia if so desired. By moving a selected one of the tabs 405a-405c of the dials 310a-310c in relation to the other two, a desired radial tab 440a, 440b and 440c protruding from an inner edge 460 of each dial 310a-310c is aligned with a circuit element or contactor member 470. Each radial tab 440a-440c includes a circuit establishing portion such as a contact pin 445a, 445b and 445c, respectively that is adapted to be in electrical communication with the contactor member 470.

The housing 320 is optionally provided with a back cover 410 which is adapted to enclose other components of the timepiece 300 including a controller 420, a light sensor 425, a speaker 430 and the movement device 335 of the time display mechanism 330. The front panel 365 includes a transparent lens 415 to allow the user to view the selected dial.

Each dial 310a-310c as illustrated in FIG. 4 is configured to be selectively positioned relative to the other dials in the selected position of the stacked arrangement within the housing 320. One of the dials 310a-310d is positioned in the selected position when the indicia 325 on the viewable surface 315 of the associated dial 310a-310d is viewable through the windows 390 in the front panel 365. The stacking order of the dials in this embodiment does not change when making different dial faces visible through the windows 395.

Dials 310a-310c become the selected dial when the contact 445a-445c on the associated radial tab 440a-440c is in communication with a protuberance 475a, 475b and 475c, respectively that extends from a circuit element or contactor 470. In one embodiment, the contactor 470 includes a tiered or stepped arrangement such that dial 310a is the selected dial when protuberance 475a is selectively engaged by contact 445a on radial tab 440a. Selecting tab 405a of dial 310a is rotatably manipulated by the user such that contact 445a engages the protuberance 475a while contacts 445b and 445c are not engaged by protuberances 475b and 475c, respectively. Similarly, dial 310b is the selected dial when protuberance 475b is selectively engaged by contact 445b on radial tab 440b. Selecting tab 405b of dial 310b is rotatably manipulated by the user such that contact 445b engages the protuberance 475b while contacts 445a and 445c are not engaged by protuberances 475a and 475c, and so on.

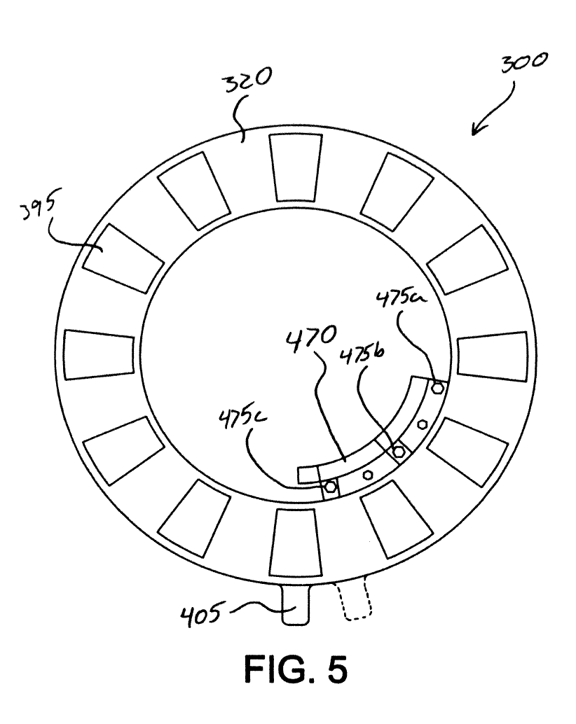

FIG. 5 illustrates contactor member 470 located relative to dials 310a-310d. The blank dial 310d is configured as the selected dial when dials 310a-310c are positioned such that none of the contacts 445a-445c are engaged by protuberances 475a-475c. In this position, windows 355a-355c of dials 310a-310c are aligned with the windows 395 of the front panel 365 allowing the viewing surface 315 of dial 310d to be viewable therein. Movement or rotation of a selected tab brings it into position as shown by dashed outline in FIG. 5. Indicia 325 of the desired dial are then visible through the windows 395.

The controller 420 is in selective communication with each contact 445a-445c of dials 310a-310c, respectively. The controller 420 is in electrical communication with the contactor member 470, the speaker 430, the light sensor 425 and the movement device 335 of the time display mechanism 330. The controller 420 is adapted to transmit one or more sounds corresponding with the selected dial such that as each dial 310a-310c is in position as the selected dial, the controller transmits one or more sounds that pertain to the particular dial 310a-310c as it is viewable from the front panel 365 of the housing 320. Each audible sound in a plurality or suite of sounds would be individually transmitted at a predetermined time normally as indicated by the location of the hour hand on the time display mechanism 330.

In one embodiment, the circuit establishing portion of the selected dial and the controller 420 can communicate electronically with a circuit element such as an infrared type sensing device (not shown). The infrared sensing device can be configured to shut off or to establish communication between the selected dial 310 and the controller 420 via completing a light path. The dials and circuit establishing portion can be adapted to complete the light path when the selected dial is in position P1 and viewable in the housing 320. Once the light path is established, a signal is provided to the controller 420 to identify which dial 310a-310d is the selected dial 310 and to transmit the at least one sound associated with that dial 310 at one or more predetermined times.

In one embodiment, each dial 310a-310c is provided with twelve indicia 325 that are radially positioned about each dial 310a-310c such that each of the twelve indicia 325 are equally spaced about the viewable surface 315. The twelve indicia 325 are configured to identify the twelve hours of each half day similar to contemporary dial faces of known U.S. timepieces. The audible suite of sounds associated with each dial 310a-310c can include twelve individual and unique sounds. If desired, the indicia and the sounds can be programmed or changed by the user.

Disclosed has been a system for a timepiece having interchangeable dials or dial portions each with different graphics having automatically changed sounds associated with each of the graphics on the dial. Each graphic dial can include an image corresponding to each hour of the day. Although it should be noted that it could be just as conceivable to have more or fewer images on the dial, and similarly, more or fewer sounds.

Each dial can include an appendage, protuberance or tab which is provided with a contact pin or the like in a unique indexed location on the appendage. A contactor member is concealed in the housing and is electrically connected to a controller such as a printed circuit board which includes a logic chip and memory chip containing the music or sounds to be transmitted. The controller is adapted to transmit the sounds through the speaker. The indicia, visible through the cover of the timepiece, are located on the dial having the appendage that engages the contactor member contained in the timepiece housing. A circuit is closed thereby sending a message to the controller to play the corresponding music or other sound at predetermined times. The graphics and sounds can be optionally changeable by the user.

The exemplary embodiments of the disclosure have been described herein. Obviously, modifications and alterations will occur to others upon reading and understanding the preceding detailed description. It is intended that the instant disclosure be construed as including all such modifications and alterations insofar as they come within the scope of the appended claims or the equivalents thereof.

1. A timepiece including a plurality of plates such that each plate is associated with at least one sound, the timepiece comprising:
a housing including a front opening;
at least one plate supported by the housing such that the at least one plate is viewable through the front opening;
a circuit establishing portion disposed on the at least one plate; and
a controller activated by the circuit establishing portion of the at least one plate, the controller being programmed to transmit at least one sound corresponding with the at least one plate, the at least one sound being transmitted at a predetermined time.

2. The timepiece according to claim 1, wherein each plate includes a plurality of indicia.

3. The timepiece according to claim 2, wherein a different audible sound is related to each indicium.

4. The timepiece according to claim 1, wherein the controller includes a number of sounds associated with a number of indicia on the at least one plate.

5. The timepiece according to claim 1 further including a time displaying mechanism for indicating the current time such that the time display mechanism is viewable from the front opening.

6. The timepiece according to claim 5, wherein the at least one plate is generally ring shaped and encircles the time display mechanism.

7. The timepiece according to claim 6, wherein the at least one plate includes a radially extending tab supporting the circuit establishing portion.

8. The timepiece according to claim 7 wherein a plurality of plates are provided and the contact portion of each tab is radially staggered in relation to the other tabs.

9. The timepiece according to claim 1, wherein a plurality of plates are aligned in the housing in a stackable arrangement.

10. The timepiece according to claim 1, wherein the timepiece comprises one of a clock or a watch.

11. The timepiece according to claim 1, wherein the housing includes a front portion selectively detachable from a rear portion so that the front portion can be repositioned to provide access to the at least one plate held in the housing.

12. The timepiece according to claim 11, further comprising a transparent cover defined in the front portion of the housing.

13. The timepiece according to claim 1 wherein the housing comprises a front portion including at least one window through which the at least one indicium of the selected plate is visible.

14. The timepiece according to claim 13 wherein the front portion includes twelve windows radially and equally spaced about the front portion.

15. The timepiece according to claim 13 wherein at least one plate includes a tab that extends outwardly from the housing and is accessible to manually move the at least one plate within the housing.

16. A method of displaying one of a plurality of plates, each plate including at least one indicium, in a housing, wherein the at least one indicium is operatively associated with at least one sound, the method comprising:
selecting a plate having at least one indicium from a plurality of plates to be viewed in the housing;
positioning the plurality of plates in a stackable arrangement in the housing such that only the selected plate is visible; and
transmitting at least one sound associated with the at least one indicium on the selected plate at a predetermined time.

17. The method according to claim 16 further including changing the plate selected in the housing, thereby changing the at least one sound transmitted.

18. A timepiece including a plurality of plates such that each plate is associated with at least one sound, the timepiece comprising:
a housing including a front opening;
a plurality of plates configured in a stacked arrangement and placed within the housing such that a selected plate is viewable through the front opening;
a circuit establishing portion provided on at least one of the plurality of plates;
a time display mechanism held within the housing and viewable through the front opening; and
a controller in communication with the circuit establishing portion, the controller being programmed to transmit, at a predetermined time, at least one sound corresponding with the selected plate.

19. The timepiece according to claim 18, wherein each of the plurality of plates comprises a ring which encircles the time display mechanism.

20. The timepiece according to claim 19, wherein the housing includes a front portion having a transparent cover and a plurality of radially spaced windows for presenting at least one indicium on the selected plate, a tab from at least one plate extending outwardly from the housing and being movable to change which plate within the housing is visible.
